(19) United States
(12) Patent Application Publication
(10) Pub. No.: US 2020/0068074 A1
(43) Pub. Date: Feb. 27, 2020

(54) NETWORK SLICE SELECTION BASED ON CHARGING RULES

(71) Applicant: Nokia Solutions and Networks Oy, Espoo (FI)

(72) Inventors: Yigang Cai, Naperville, IL (US); Ranjan Sharma, New Albany, OH (US)

(21) Appl. No.: 16/611,839

(22) PCT Filed: Jun. 29, 2017
(86) PCT No.: PCT/US17/39978

§ 371 Date: Nov. 7, 2019

(51) Int. Cl. H04M 15/00; H04W 4/24; H04W 48/18

(52) U.S. Cl. CPC H04M 15/66; H04M 15/8235; H04W 48/18; H04W 4/24

(57) ABSTRACT

Systems, methods, and software for selecting a network slice for User Equipment (UE) in a network that is partitioned into network slices. In one embodiment, a slice selection server receives an attach request intiated by the UE to attach to the network, sends a request to a policy control server to obtain a slice selection policy for the UE, and receives a response from the policy control server indicating a plurality of charging rules for the UE that are each mapped to a different one of the network slices. The slice selection server selects a network slice for the UE based on the charging rules, and sends an attach response to the UE that includes a network slice identifier (ID) for the network slice selected for the UE.

### RELATED APPLICATIONS

The present application is a National Stage entry of PCT application No. PCT/US2017/039978 filed on Jun. 29, 2017, which is fully incorporated herein by reference.

### FIELD OF THE INVENTION

The invention is related to the field of communication systems and, in particular, to network slicing.

### BACKGROUND

Next generation wireless networks (e.g., 5^{th} Generation or 5G) will need to support demands from a variety of users, machines, industries, organizations, etc. Thus, next generation wireless networks will have to support a variety of requirements for latency, throughput, capacity, and availability. To provide support for different types of services, use-cases, and business models, the physical network may be partitioned into multiple virtual instances, which is referred to as network slicing. Network slicing offers an effective way to meet different use-case requirements and exploit the benefits of a common network infrastructure.

Present solutions for selecting a network slice for a mobile device may be insufficient, and it may be desirable to identify improved ways of selecting a network slice.

### SUMMARY

Embodiments described herein consider charging rules when selecting a network slice. A communication device (e.g., User Equipment (UE)) may be authorized to access multiple network slices that are apportioned within a network. Previous suggestions were to select a network slice for the UE that supported service requirements, such as latency, throughput, capacity, and availability. The embodiments described herein also consider the best interests of the UE/subscriber from a charging prospective. Thus, a network slice is selected for a UE based on charging rules and possibly other information.

One embodiment comprises a slice selection server of a network that is partitioned into network slices. The slice selection server comprises a first interface component configured to receive an attach request initiated by a UE to attach to the network, and a second interface component configured to communicate with a policy control server. The slice selection server includes a first processor that implements a slice selection function, where in response to the attach request, the slice selection function is configured to send a first request to the policy control server through the second interface component to obtain a slice selection policy for the UE, and to receive a first response from the policy control server through the second interface component that includes the slice selection policy indicating a plurality of charging rules for the UE that are each mapped to a different one of the network slices. The slice selection function is configured to select a network slice for the UE based on the charging rules, and to send an attach response to the UE through the first interface component that includes a network slice ID for the network slice selected for the UE.

In another embodiment, the slice selection function is configured to insert a charging rule ID in the attach response for one of the charging rules that is mapped to the network slice selected for the UE.

In another embodiment, the slice selection function is configured to embed the charging rule ID in the network slice ID.

In another embodiment, the policy control server comprises a third interface component configured to receive the first request from the slice selection server, and a fourth interface component configured to communicate with an account charging server. The policy control server comprises a second processor that implements an acquisition module configured to send a second request to the account charging server through the fourth interface component to obtain a charging policy for the UE, and to receive a second response from the account charging server through the fourth interface component that includes the charging policy indicating the charging rules for the UE that are each mapped to a different one of the network slices. The second processor implements a rules engine configured to process the charging rules in the second response from the account charging server to formulate the slice selection policy for the UE, and to send the first response to the slice selection server through the third interface component that includes the slice selection policy indicating the charging rules for the UE that are each mapped to a different one of the network slices.

In another embodiment, the second processor further implements a priority module configured to prioritize the charging rules for the UE, and to insert an indication of the priority in the charging rules.

In another embodiment, the account charging server comprises a fifth interface component configured to receive the second request from the policy control server, and a third processor that implements a charging policy manager configured to determine the charging rules for the UE that are each mapped to a different one of the network slices. The charging policy manager is configured to send the second response to the policy control server through the fifth interface component that includes the charging policy indicating the charging rules for the UE that are each mapped to a different one of the network slices.

In another embodiment, the charging policy manager is configured to assign a validity timer to each of the charging rules, and to populate a parameter of the charging rules with the validity timer.

In another embodiment, the third processor further implements an account balance manager that maintains an account associated with the UE. The charging policy manager is configured to populate a parameter of the charging rules with information regarding the account.

In another embodiment, the third processor further implements a rating engine that determines tariffs for the network slices that are mapped to the charging rules. The charging policy manager is configured to populate a parameter of a charging rule with a tariff for a network slice mapped to the charging rule.

Another embodiment comprises method operable in a network that is partitioned into network slices. The method includes receiving, in a slice selection server, an attach request initiated by a UE to attach to the network. The method includes sending a first request from the slice selection server to a policy control server to obtain a slice selection policy for the UE, and receiving a first response in the slice selection server from the policy control server that includes the slice selection policy indicating a plurality of charging rules for the UE that are each mapped to a different one of the network slices. The method includes selecting a network slice for the UE based on the charging rules, and sending an attach response from the slice selection server to the UE that includes a network slice ID for the network slice selected for the UE.

In another embodiment, the method includes inserting a charging rule ID in the attach response for one of the charging rules that is mapped to the network slice selected for the UE.

In another embodiment, the step of inserting a charging rule ID in the attach response comprises embedding the charging rule ID in the network slice ID.

In another embodiment, the method includes receiving the first request in the policy control server from the slice selection server, sending a second request from the policy control server to an account charging server to obtain a charging policy for the UE, and receiving a second response in the policy control server from the account charging server that includes the charging policy indicating the charging rules for the UE that are each mapped to a different one of the network slices. The method includes processing, at the policy control server, the charging rules in the second response from the account charging server to formulate the slice selection policy for the UE, and sending the first response from the policy control server to the slice selection server that includes the slice selection policy indicating the charging rules for the UE that are each mapped to a different one of the network slices.

In another embodiment, the method includes prioritizing the charging rules for the UE, and inserting an indication of the priority in the charging rules.

In another embodiment, the method includes receiving the second request in the account charging server from the policy control server, determining the charging rules for the UE that are each mapped to a different one of the network slices, and sending the second response from the account charging server to the policy control server that includes the charging policy indicating the charging rules for the UE that are each mapped to a different one of the network slices.

In another embodiment, the method includes assigning a validity timer to each of the charging rules, and populating a parameter of the charging rules with the validity timer.

In another embodiment, the method includes maintaining an account associated with the UE, and populating a parameter of the charging rules with information regarding the account.

In another embodiment, the method includes determining tariffs for the network slices that are mapped to the charging rules, and populating a parameter of a charging rule with a tariff for a network slice mapped to the charging rule.

Another embodiment comprises a non-transitory computer readable medium embodying programmed instructions executed by one or more processors, wherein the instructions direct the processors to implement a slice selection server of a network that is partitioned into network slices. The slice selection server receives an attach request initiated by a UE to attach to the network. In response to the attach request, the slice selection server sends a request to a policy control server to obtain a slice selection policy for the UE, and receives a response from the policy control server that includes the slice selection policy indicating a plurality of charging rules for the UE that are each mapped to a different one of the network slices. The slice selection server selects a network slice for the UE based on the charging rules, and sends an attach response to the UE that includes a network slice ID for the network slice selected for the UE.

In another embodiment, the slice selection server inserts a charging rule ID in the attach response for one of the charging rules that is mapped to the network slice selected for the UE.

Another embodiment comprises a policy control server that includes a first interface component configured to receive a first request from a slice selection server for a slice selection policy for a UE that is attaching to a network that is partitioned into network slices. The policy control server includes a second interface component configured to communicate with an account charging server. The policy control server includes a processor that implements an acquisition module configured to send a second request to the account charging server through the second interface component to obtain a charging policy for the UE, and to receive a first response from the account charging server through the second interface component that includes the charging policy indicating charging rules for the UE that are each mapped to a different one of the network slices. The processor implements a rules engine configured to process the charging rules in the first response from the account charging server to formulate the slice selection policy for the UE, and to send a second response to the slice selection server through the first interface component that includes the slice selection policy indicating the charging rules for the UE that are each mapped to a different one of the network slices.

Another embodiment comprises a method that includes receiving, in a policy control server, a first request from a slice selection server for a slice selection policy for a UE that is attaching to a network that is partitioned into network slices. The method includes sending a second request from the policy control server to the account charging server to obtain a charging policy for the UE, receiving a first response in the policy control server from the account charging server that includes the charging policy indicating charging rules for the UE that are each mapped to a different one of the network slices, processing the charging rules in the first response from the account charging server to formulate the slice selection policy for the UE, and sending a second response from the policy control server to the slice selection server that includes the slice selection policy indicating the charging rules for the UE that are each mapped to a different one of the network slices.

Another embodiment comprises a slice selection server of a network that is partitioned into network slices. The slice selection server comprises a means for receiving an attach request initiated by a UE to attach to the network, and a means for communicating with a policy control server. The slice selection server includes a means for implementing a slice selection function, where in response to the attach request, the slice selection function is configured to send a first request to the policy control server to obtain a slice selection policy for the UE, and to receive a first response from the policy control server that includes the slice selection policy indicating a plurality of charging rules for the UE that are each mapped to a different one of the network slices. The slice selection function is configured to select a network slice for the UE based on the charging rules, and to send an attach response to the UE that includes a network slice ID for the network slice selected for the UE.

In another embodiment, the policy control server comprises a means for receiving the first request from the slice selection server, and a means for communicating with an account charging server. The policy control server comprises a means for implementing an acquisition module configured to send a second request to the account charging server to obtain a charging policy for the UE, and to receive a second response from the account charging server that includes the charging policy indicating the charging rules for the UE that are each mapped to a different one of the network slices. The policy control server comprises a means for implementing a rules engine configured to process the charging rules in the second response from the account charging server to formulate the slice selection policy for the UE, and to send the first response to the slice selection server that includes the slice selection policy indicating the charging rules for the UE that are each mapped to a different one of the network slices.

In another embodiment, the account charging server comprises a means for receiving the second request from the policy control server, and a means for implementing a charging policy manager configured to determine the charging rules for the UE that are each mapped to a different one of the network slices. The charging policy manager is configured to send the second response to the policy control server that includes the charging policy indicating the charging rules for the UE that are each mapped to a different one of the network slices.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a high-level architecture of a next generation mobile network.

FIG. 2 illustrates a network slicing architecture.

FIG. 3 illustrates an initial attach procedure for a UE.

FIG. 4 illustrates a new session establishment procedure for a UE.

FIG. 5 illustrates a network slicing architecture in an exemplary embodiment.

FIG. 6 is a block diagram of a slice selection server in an exemplary embodiment.

FIG. 7 is a block diagram of a policy control server in an exemplary embodiment.

FIG. 8 is a block diagram of an account charging server in an exemplary embodiment.

FIG. 9 illustrates an attach procedure for a UE in an exemplary embodiment.

FIGS. 10-12 are flow charts illustrating a method of selecting a network slice in an exemplary embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

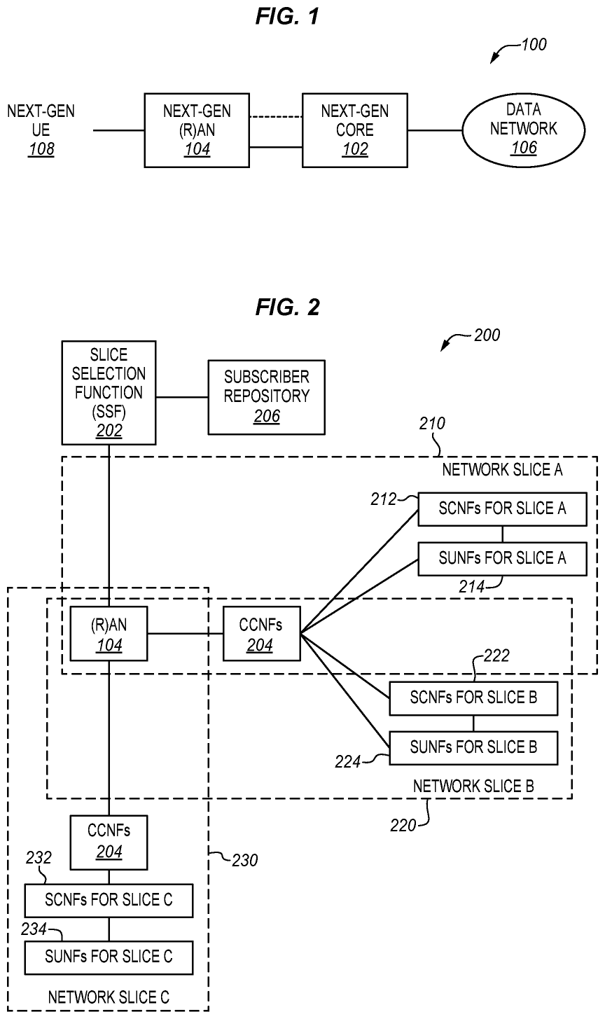

FIG. 1 illustrates a high-level architecture of a next generation mobile network 100 as described in Third Generation Partnership Project (3GPP) TR 23.799 (version 14.0.0), which is incorporated by reference as if fully included herein. Network 100 includes a next generation (Next-Gen) core network 102 and a next generation access network and/or radio access network ((R)AN) 104. Access network 104 may support Evolved-UMTS Terrestrial Radio Access Network (E-UTRAN) access, Wireless Local Area Network (WLAN) access, fixed access, satellite radio access, new Radio Access Technologies (RAT), etc. Core network 102 interconnects access network 104 with a data network 106. Data network 106 may be an operator external public or private data network, or an intra-operator data network (e.g., for IMS services). Next generation User Equipment (UE) 108 is able to attach to access network 104 to access services from core network 102.

One goal of next generation networks (e.g., 5G) is to enable network slicing. With network slicing, a physical network may be partitioned into multiple virtual instances so that a mobile operator can offer support for different types of services for different types of customer segments. A network slice is a logical representation of network functions and corresponding resource requirements necessary to provide the required telecommunication services and network capabilities. For example, a mobile operator may provide a network slice for Machine-Type Communications (MTC) devices or Internet of Things (IoT) devices, which offers a reliable data-only service with a given latency, data rate, and security level. The mobile operator may also provide a network slice with very high throughput, high data speeds, and low latency for real-time or on-demand services. The mobile operator may provide other network slices that provide the required telecommunication services and network capabilities. The core network part of a network slice is referred to as the CN slice, and the radio network part of a network slice is referred to as the RAN Slice.

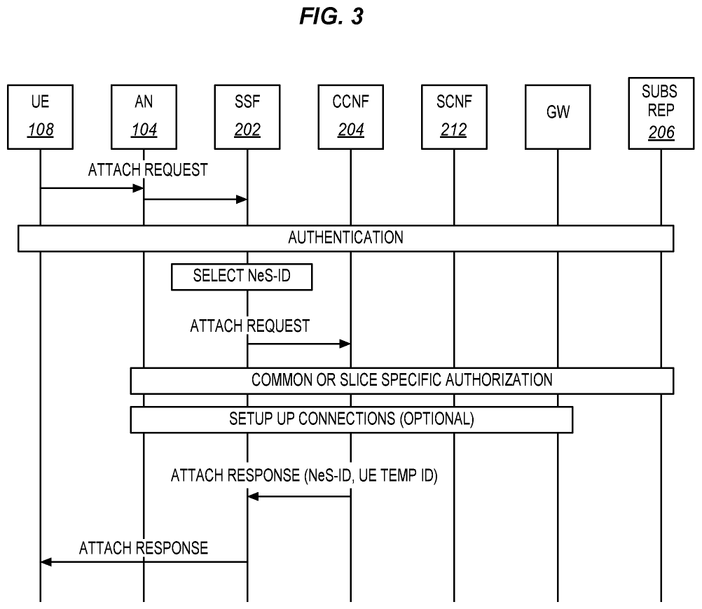

FIG. 2 illustrates a network slicing architecture 200, as is further described in 3GPP TR 23.799. In this architecture, the control plane of core network 102 (see FIG. 1) is partitioned into three types of Network Functions (NFs). A network function is a processing function in a network, which may be implemented as a network element on dedicated hardware, as a software instance running on dedicated hardware, or as a virtualized function instantiated on an appropriate platform (e.g., on a cloud infrastructure). One type of network function is a Slice Selection Function (SSF) 202. SSF 202 handles an initial attach request and session establishment request from UE 108 by selecting an appropriate network slice for UE 108 based on subscription information, UE usage type, service type, and UE capabilities. SSF 202 connects with a subscriber repository 206 (e.g., Home Subscriber Server (HSS) and/or Subscriber Profile Repository (SPR)), which is a database or databases that stores subscriber-related information, which may be referred to as subscriber profiles. Another type of network function is a Common Control Plane Network Function (CCNF) 204. CCNF 204 is the control plane entry function that is shared among different network slices, and includes the Mobility Management (MM) function, the authentication (AU) function, and the NAS Proxy function. Another type of network function is a Slice-Specific Control Plane Network Function (SCNF). A SCNF is allocated to a particular network slice (i.e., not shared among network slices), and has no direct interface with access network 104. The NFs that are allocated to a particular network slice are configured to support a particular set of functionalities, such as session management and QoS framework.

The network in FIG. 2 is partitioned into three network slices: network slice A 210, network slice B 220, and network slice C 230. SCNFs 212 are allocated to network slice A 210 for core network 102, SCNFs 222 are allocated to network slice B 220 for core network 102, and SCNFs 232 are allocated to network slice C 230 for core network 102. Slice-Specific User Plane Network Functions (SUNF) are also allocated to each network slice, such as SUNFs 214 for network slice A 210, SUNFs 224 for network slice B 220, and SUNFs 234 for network slice C 230. Each network slice 210, 220, and 230 is associated with a network slice ID (e.g., NeS-ID or slice instance ID). The NeS-ID may be separated into two parts. One part is the type of common CP (CCNF ID). When different types of network slices share a CCNF, the CCNF needs to accommodate the requirements from the different network slices. The type of common CP reflects the requirements for the CCNF. Another part of the NeS-ID is the type of slice-specific part, which indicates the type of non-shared slice CN parts.

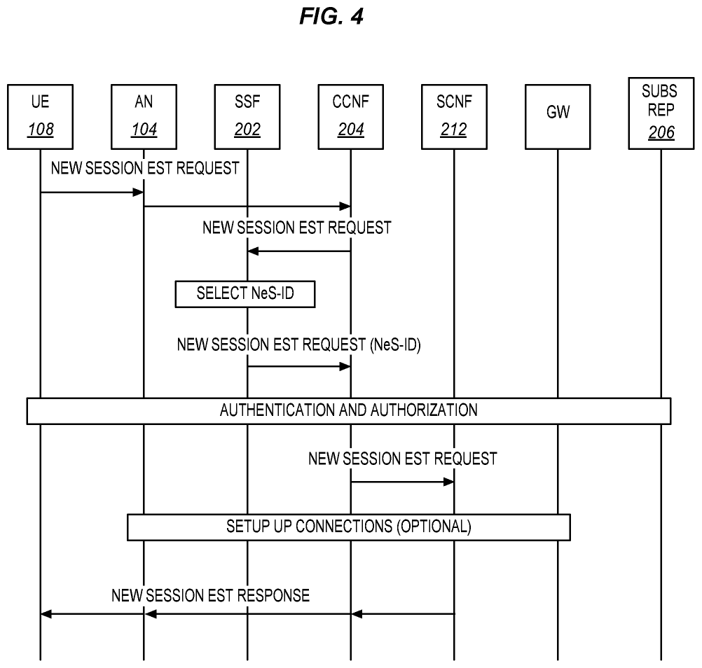

FIG. 3 illustrates an initial attach procedure for UE 108. When UE 108 first attaches to the network, UE 108 sends an initial attach request to access network (AN) 104 including UE capabilities and the requested service (optional). Access network 104 forwards the attach request to SSF 202. SSF 202 accesses the subscriber repository 206, and authenticates UE 108 to determine whether it is permitted to access the network. SSF 202 selects the appropriate network slice type as well as the related NeS-ID for a network slice or Network Slice Instance (NSI) based on the information received from UE 108 in the attach request and a subscriber profile retrieved from subscriber repository 206, such as UE's subscription information, UE usage type, service type, and UE capability.

SSF 202 forwards the attach request with the NeS-ID to CCNF 204 and/or to SCNF 212 of the selected network slice. CCNF 204 performs an authentication/slice authorization procedure by checking the UE identity with subscriber repository 206. The procedure determines whether UE 108 is authorized to access this network slice. At this point, UP (user plane) connections for a default or UE-specified type network slice may be set up. CCNF 204 sends an attach response to SSF 202 that includes the NeS-ID and a UE Temporary ID. The UE Temporary ID is assigned by CCNF 204, and may consist of the routing information to CCNF 204 and a UE-specific identity (similar to an M-TMSI). SSF 202 sends the attach response to UE 108 via access network 104 with the NeS-ID and the UE Temporary ID. When UE 108 receives the NeS-ID and the UE Temporary ID, it may use this information to assist in future network slice selection (e.g., when UE 108 detaches from the network and re-attaches again). If UE 108 re-attaches to the network after receiving the NeS-ID and the UE Temporary ID, it may send an attach request to access network 104 with the NeS-ID and the UE Temporary ID. If the UE Temporary ID is valid, then access network 104 may forward the attach request directly to CCNF 204 based on the UE Temporary ID. Otherwise, access network 104 selects CCNF 204 based on the NeS-ID.

If no UP connection is setup or if only a default UP connection is setup for UE 108 and it requests a service that is provided by another network slice, then another UP connection for UE 108 is setup during a new session establishment procedure.

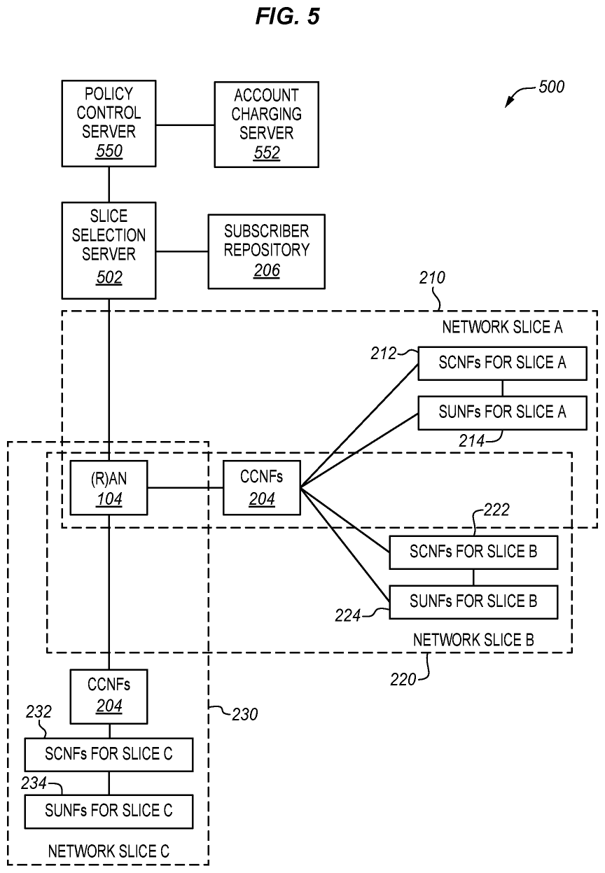

FIG. 4 illustrates a new session establishment procedure for UE 108. To begin, UE 108 sends a request for establishment of a new session to access network 104. Access network 104 forwards the new session establishment request to CCNF 204 based on the UE Temporary ID, which was allocated during the attach procedure. If CCNF 204 does not know which SCNF part to handle this request, then CCNF 204 forwards the new session establishment request to SSF 202 to determine which network slice to select. SSF 202 selects the appropriate new NeS-ID. It is assumed that the new NeS-ID shared the same type of CCNF, but with a different type of SCNF part. SSF 202 sends the new session establishment request with the NeS ID to CCNF 204. If UE 108 has already been authenticated and the new network slice requires the same authentication procedure, then CCNF 204 only performs the authorization procedure. If CCNF 204 is a common function for all network slices, then the authentication procedure is only performed for the first network slice that is associated with CCNF 204. CCNF 204 forwards the new session establishment request to SCNF 212. SCNF 212 performs a session management procedure to setup the UP connection, and sends a new session establishment response to UE 108 through CCNF 204 and access network 104.

Once UE 108 is assigned to a CCNF during the attach procedure, the signaling connection between UE 108 and the CCNF is based on the UE Temporary ID (i.e., the RAN part of the network slice routes UE signaling to the CCNF based on the UE Temporary ID). The CCNF is logically part of all the Network Slice Instances (NSIs) that are being used for UE 108. When a new NSI is added to or an existing NSI is removed from the set of network slices used by UE 108, a more optimal CCNF may be selected to serve the new set of NSIs used for UE 108.

Network slice or NSI selection as described above enables the selection of a set of network functions to deliver a certain service and/or for a certain use case. A network slice offers particular system behaviors to UE 108 that are tailored to application needs from the standpoint of specific control plane or user plane behaviors, and offers UE 108 access to resources allocated for a specific service or application domain, or a tenant (e.g., minimum level of guaranteed resources or aggregate number of subscribers allowed to access the service at any point in time). In selection of a network slice, a Multi-Dimensional Descriptor (MDD) may be configured in UE 108 and provided to the network during the attach procedure. An MDD may include the following components: a first component identifying a tenant, and a second component identifying network behaviors for the target network service identified by the slice type. SSF 202 may use the MDD along with the UE's capability, the UE's location, and subscription data to select a network slice. By leveraging the UE's capability and subscription data from subscriber repository 206 in addition to the MDD, UE 108 is authorized at attach time to access certain NSIs that correspond to certain MDD values.

The binding of UE 108 to a network slice happens when the network receives the attach request from UE 108. As presently suggested, the selection of a network slice by SSF 202 is based on subscription information, UE usage type, service type, UE capabilities, and MDD, and each network slice is mapped to static information and policies. From a usage perspective, static policies are insufficient to handle subscriptions that change with usage and exhibit dynamism. In other words, statically-defined policies can only address a few profile conditions, but cannot fulfill a dynamic profile need. For charging, the subscriber's service plan and policy varies with several factors, such as initial Quality of Service (QoS) allocation, already consumed quota, temporal details of the billing cycle, whether the subscriber is within the network or in a partner network, whether smart charging is active, whether the subscriber has opted for spending limits and is therefore subject to close monitoring around when the consumed quota approaches a threshold, etc. In the embodiments described herein, charging rules for UEs are acquired to select an appropriate network slice for the UEs.

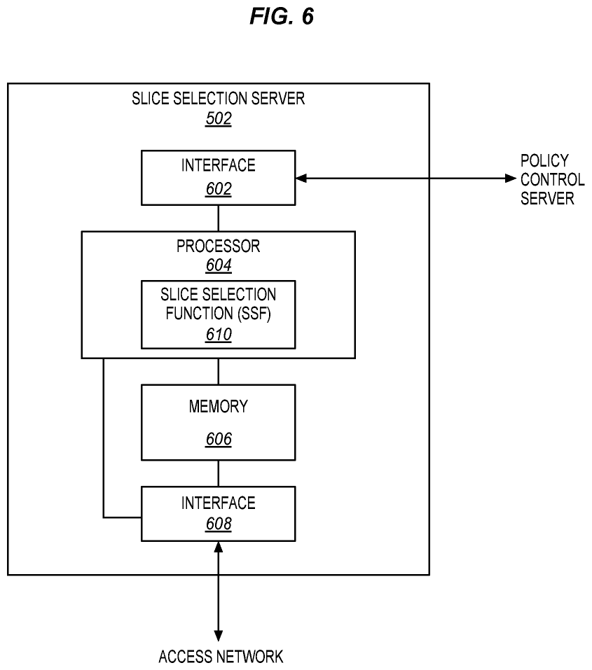

FIG. 5 illustrates a network slicing architecture 500 in an exemplary embodiment. Architecture 500 is a system or network that is partitioned into multiple network slices, and slice-specific network functions are allocated to each network slice. Some elements of architecture 500 are similar to the elements of architecture 200 shown in FIG. 2. In this embodiment, architecture 500 includes a slice selection server 502, a policy control server 550, and an account charging server 552. Slice selection server 502 is configured to communicate with policy control server 550 and/or account charging server 552 when selecting a network slice or NSI for a UE. Although shown as a separate element, policy control server 550 may be implemented within slice selection server 502 in another embodiment.

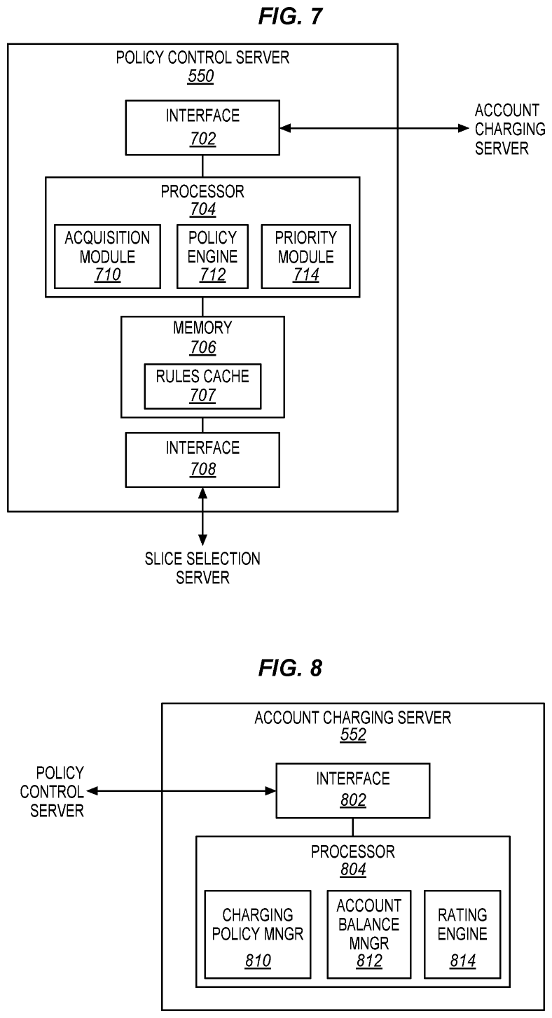

FIG. 6 is a block diagram of slice selection server 502 in an exemplary embodiment. Slice selection server 502 is an element of a core network (e.g., core network 102) that is configured to select a network slice or NSI for a UE in response to an attach request from the UE. Slice selection server 502 includes an interface component 602 configured to communicate with policy control server 550, one or more processors 604, a memory 606, and an interface component 608 configured to communicate with access network 104. Interface component 602 may comprise a hardware component or device that exchanges messages with policy control server 550. Processor 604 represents the internal circuitry, logic, hardware, etc., that provides the functions of slice selection server 502. Memory 606 is a computer readable storage medium (e.g., ROM or flash memory) for data, instructions, applications, etc., and is accessible by processor 604. Interface component 608 may comprise a hardware component or device that exchanges messages with an access network 104 via a protocol, such as Non-Access Stratum (NAS) protocol. Slice selection server 502 may include various other components not specifically illustrated in FIG. 6.

Processor 604 implements a Slice Selection Function (SSF) 610 that is configured to select a network slice or NSI for a UE. SSF 610 is enhanced in this embodiment to select a network slice or NSI for a UE based on the charging rules associated with the UE/subscriber. SSF 610 may query policy control server 550 to identify the charging rules associated with the UE. SSF 610 may also consider other information, such as subscription information, UE usage type, service type, UE capabilities, and MDD, in selecting the network slice. SSF 610 may use selection criteria to select a network slice for a UE, which may be stored in memory 606.

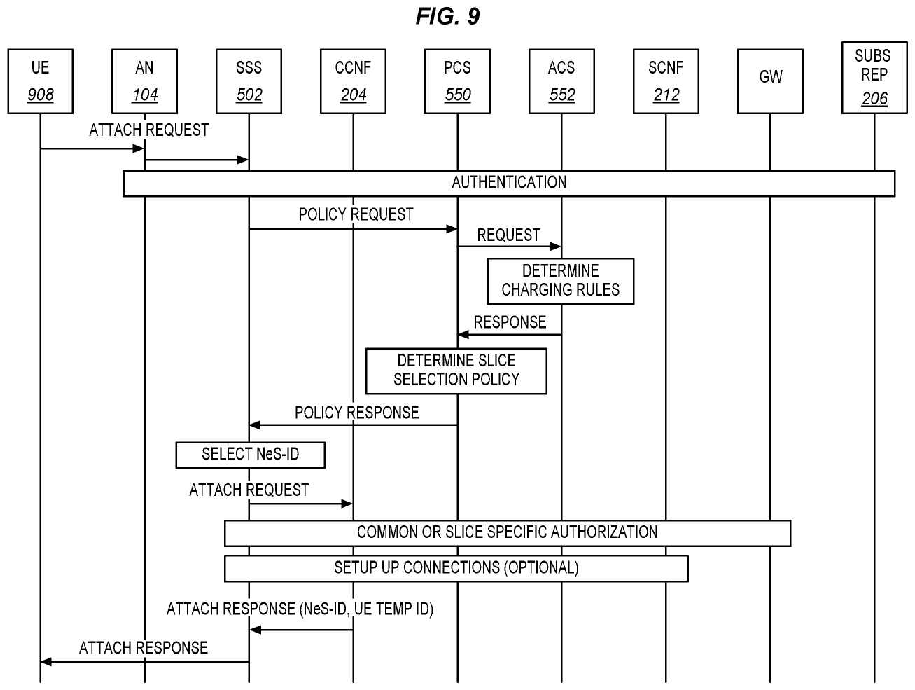

FIG. 7 is a block diagram of policy control server 550 in an exemplary embodiment. Policy control server 550 is an element of a core network (e.g., core network 102) that identifies a charging policy for a UE, where the charging policy includes a plurality of charging rules. Policy control server 550 includes an interface component 702 configured to communicate with account charging server 552, one or more processors 704, a memory 706, and an interface component 708 configured to communicate with slice selection server 502. Interface component 702 may comprise a hardware component or device that exchanges messages with account charging server 552. Processor 704 represents the internal circuitry, logic, hardware, etc., that provides the functions of policy control server 550. Memory 706 is a computer readable storage medium for data, instructions, applications, etc., and is accessible by processor 704. Memory 706 may provide a rules cache 707 that stores charging rules for a network operator. Interface component 708 may comprise a hardware component or device that exchanges messages with slice selection server 502. Policy control server 550 may include various other components not specifically illustrated in FIG. 7.

Processor 704 implements an acquisition module 710, a policy engine 712, and a priority module 714. Acquisition module 710 is configured to acquire charging rules for a UE from a local rules cache, from account charging server 552, or from another server or database. Acquisition module 710 may also store charging rules acquired from an external server or database in rules cache 707, such as for a configurable time period. Policy engine 712 may store operator-provisioned rules, may acquire subscriber profiles for UEs, and may acquire information on network conditions, such as Key Performance Indicators (PM) related to traffic and bandwidth, QoS, etc. Policy engine 712 is configured process charging rules for a UE, the operator-provisioned rules, the network conditions, etc., to formulate a slice selection policy. Priority module 714 is configured to prioritize charging rules for a UE based on a policy or criteria. For example, the policy used by priority module 714 may consider Time-of-Day (TOD), Day-of-Week (DOW), peak time, off-peak time, network conditions, etc., when prioritizing the charging rules.

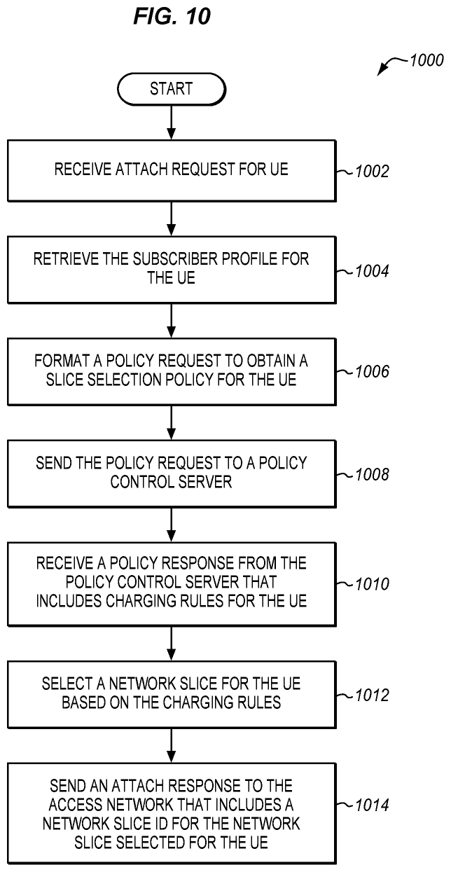

FIG. 8 is a block diagram of account charging server 552 in an exemplary embodiment. Account charging server 552 is an element of a core network (e.g., core network 102) that provides charging control for the core network. Account charging server 552 may include functionalities of an Online Charging System (OCS) and/or an Offline Charging System (OFCS). In this embodiment, account charging server 552 includes an interface component 802 configured to communicate with policy control server 550, and one or more processors 804. Interface component 802 may comprise a hardware component or device that exchanges messages with policy control server 550. Processor 804 represents the internal circuitry, logic, hardware, etc., that provides the functions of account charging server 552. Account charging server 552 may include various other components not specifically illustrated in FIG. 8.

Processor 804 implements a charging policy manager 810, an account balance manager 812, and a rating engine 814. Charging policy manager 810 is configured to determine or identify a charging policy for a UE. The UE may have multiple service plans associated with different network slices. The different network slices may be at different service tiers or price points. For example, one service plan of the UE may be associated with network slice A (or the type of network slice A), another service plan of the UE may be associated with network slice B (or the type of network slice B), and another service plan of the UE may be associated with network slice C (or the type of network slice C). Charging policy manager 810 is able to determine or identify charging rules that are mapped to each network slice authorized for the UE based on its subscription. The charging rules may have a variety of parameters, such as Quality of Service (QoS), a rate or tariff, a consumed quota for the UE, usage during a billing cycle for the UE, temporal details of a billing cycle for the UE, whether the UE is located within the network or in a partner network, whether smart charging is active, whether the subscriber has opted for spending limits, etc. Charging policy manager 810 may also assign a validity timer to the charging rules.

Account balance manager 812 is configured to control or maintain one or more accounts for a UE. One account may comprise an online or prepaid account that is maintained or updated by account balance manager 812. Another account may comprise an offline or postpaid account, where account balance manager 812 monitors usage of a UE during a billing cycle (e.g., a month). Account balance manager 812 is configured to determine a present account balance a UE, a remaining quota for a UE, present usage during a billing cycle, temporal details of a billing cycle (e.g., time remaining in a billing cycle or time spent during a billing cycle), spend limits defined by a subscriber, or other account information related to the UE.

Rating engine 814 is configured to determine a rate or tariff for network resource usage by a UE. The rate or tariff (also referred as rate plan) may comprise a static tariff or a dynamic tariff. For example, a static tariff may indicate a cost/price for a service based on a service plan. A dynamic tariff may depend on usage, service types, etc. Rating engine 814 may receive information for chargeable events in the form of credit requests (e.g., Credit Control Requests (CCR)), accounting requests (e.g., Accounting Requests (ACR)), Charging Data Records (CDRs), which describe the usage of a UE and/or a service description. Rating engine 814 may then calculate the cost/price of the chargeable event as per the tariff, and store the rated event for billing purposes or send the rated event to an external system for billing. In the case of online charging, account balance manager 812 may decrement the account of the UE based on the tariff determined for a chargeable event. Rating engine 814 is also configured to determine a rate or tariff for each network slice authorized for the UE. When the UE is authorized for different network slices, the rate or tariff applicable to each network slice may be different. For example, a network slice configured for low-latency and high QoS may have a higher tariff than another network slice configured for low QoS.

In this embodiment, policy control server 550 and account charging server 552 are used to support slice selection server 502 in selecting a network slice for a UE. Slice selection server 502 will consult with policy control server 550 and account charging server 552 for additional data (e.g., charging rules) when it receives an attach request from a UE. Thus, slice selection server 502 will have more information to use in selecting a network slice for a UE.

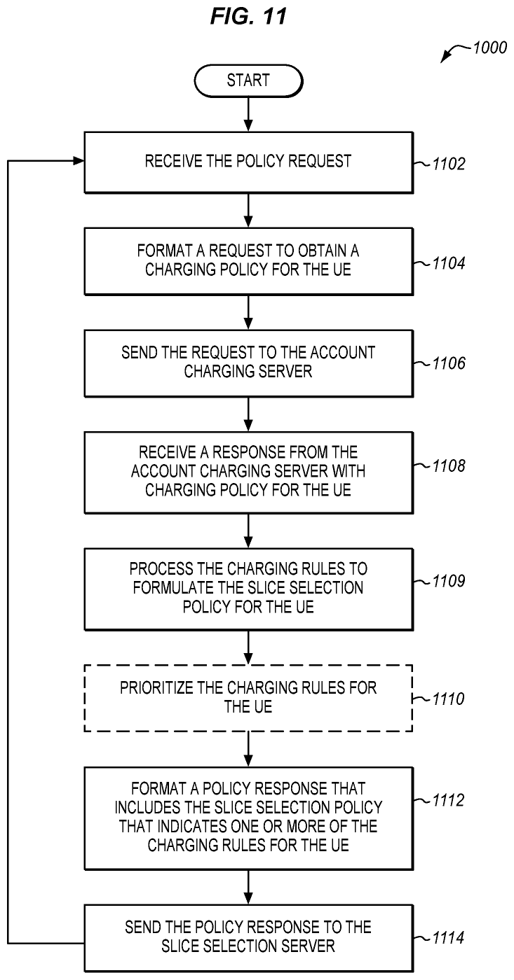

FIG. 9 illustrates an attach procedure for a UE 908 in an exemplary embodiment. When UE 908 attaches to the network, UE 908 sends an attach request to access network (AN) 104 including UE capability and the requested service (optional). Access network 104 forwards the attach request to slice selection server (SSS) 502. In response to the attach request, slice selection server 502 may access subscriber repository 206 to obtain a subscriber profile for UE 908. According to this embodiment, slice selection server 502 is enhanced to acquire additional information for selecting a network slice for UE 908. Thus, slice selection server 502 sends a policy request to policy control server (PCS) 550, in response to receiving the attach request, to acquire a slice selection policy for UE 908. Policy control server 550 sends a request to account charging server (ACS) 552 for a charging policy for UE 908. In response to the request, account charging server 552 determines, acquires, or otherwise identifies the charging policy for UE 908. For the charging policy, account charging server 552 may determine a plurality of charging rules for UE 908, where the charging rules are mapped to different network slices authorized for UE 908. Account charging server 552 sends a response to policy control server 550 with the charging rules for UE 908. Policy control server 550 determines the slice selection policy based on the charging rules, and sends a policy response to slice selection server 502 indicating the slice selection policy.

Slice selection server 502 selects the appropriate network slice for UE 908 based, at least in part, on the charging rules for UE 908. Signaling may continue much as described in FIG. 3, where an attach response is provided to UE 908 with a network slice ID (e.g., NeS-ID). The attach response may also indicate a charging rule ID for the selected network slice. The charging rule ID indicates a charging rule, and rate for usages and services requested in the attach request.

UE 908 may process the charging rule ID and network slice ID. If UE 908 discovers the charging rule and/or rate do not meet its expectation (assuming the subscriber has multiple service plans with multiple charging rules), UE 908 may re-request a new network slice with the same usage and service type(s). Slice selection server 502 re-evaluates the re-request and may re-consult with policy control server 550 and account charging server 552, or may respond with a dataset stored locally, as it would have information in its cache about the multiple charging rules from the initial consultation. Slice selection server 502 may then select an alternate network slice for UE 908.

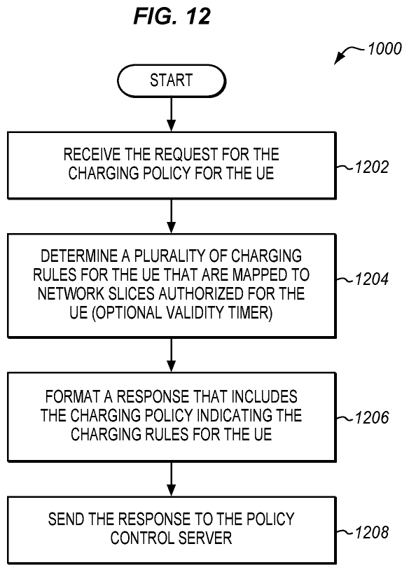

Further details of selecting a network slice for UE 908 is described in FIGS. 10-12. FIGS. 10-12 are flow charts illustrating a method 1000 of selecting a network slice in an exemplary embodiment. The steps of method 1000 will be described with reference to architecture 500 in FIG. 5, but those skilled in the art will appreciate that method 1000 may be performed in other architectures. Also, the steps of the flow charts described herein are not all inclusive and may include other steps not shown, and the steps may be performed in an alternative order.

In FIG. 10, interface component 608 (see also, FIG. 6) of slice selection server 502 receives the attach request for UE 908 from access network 104 (step 1002). In response to the attach request, SSF 610 initiates a selection procedure for selecting a network slice for UE 908. For the selection procedure, SSF 610 may retrieve the subscriber profile for UE 908 from subscriber repository 206 (step 1004), and extract information from the attach request. SSF 610 is also programmed to retrieve or obtain a slice selection policy for UE 908 from policy control server 550. Thus, SSF 610 formats a policy request to obtain the slice selection policy for UE 908 (step 1006), and sends the policy request to policy control server 550 through interface component 602 (step 1008).

In FIG. 11, policy control server 550 (see also, FIG. 7) receives the policy request from SSF 610 through interface component 708 (step 1102). The policy request received by interface component 708 may include subscriber data, service types, or other data received from UE 908 or identified in the subscriber profile associated with UE 908. In response to the policy request, acquisition module 710 in policy control server 550 formats a request to obtain a charging policy for UE 908 (step 1104), and sends the request to account charging server 552 through interface component 702 (step 1106).

In FIG. 12, interface component 802 (see also, FIG. 8) of account charging server 552 receives the request from policy control server 550 (step 1202). In response to the request, charging policy manager 810 determines or identifies a plurality of charging rules for UE 908 (step 1204) that make up the charging policy for UE 908. As stated above, the subscription of UE 908 has a service plan or multiple services plans that are associated with different network slices or even different network slice types. Thus, UE 908 is authorized to access services provided by different network slices. Charging policy manager 810 determines or identifies charging rules that are mapped to each network slice authorized for UE 908. In other words, for each network slice authorized for UE 908, a charging rule is mapped to that network slice. Charging policy manager 810 may also identify or assign a validity timer to the charging rules for each network slice.

The charging rules may have parameters that are pre-populated based on the service plan, such as a Quality of Service (QoS) allocated to UE 908, a charging method (offline/online), whether smart charging is activated, spending limits, etc. The charging rules may have parameters that are dynamically populated by charging policy manager 810. For example, a charging rule may have one or more parameters regarding an account associated with UE 908. Charging policy manager 810 may query account balance manager 812 for information on the subscriber's account. Account balance manager 812 may identify a consumed quota of an online account, present usage for UE 908 during a billing cycle, temporal details of a billing cycle (e.g., time remaining in a billing cycle or time spent during a billing cycle), etc., and reply back to charging policy manager 810. Charging policy manager 810 may query rating engine 814 for a rate or tariff applicable to a network slice. Rating engine 814 may determine a rate, tariff, or rating group for different network slices, validity timers for the tariffs, etc., and reply back to charging policy manager 810. The rate may be statically-defined for the network slice, or may be a dynamic rate based on conditions, such as TOD, DOW, peak/off-peak, network conditions, etc. Charging policy manager 810 formats a response that includes the charging policy for UE 908 indicating the charging rules for UE 908 that are mapped to a network slice (step 1206). In formatting the response, charging policy manager 810 may populate (i.e., insert data into) parameters of the charging rules based on information acquired from account balance manager 812 and rating engine 814, such as by inserting information regarding an account associated with UE 908, a tariff for a network slice mapped to a charging rule, etc. Charging policy manager 810 may also populate a parameter of the charging rules with their associated validity timer. Charging policy manager 810 then sends the response to policy control server 550 through interface component 802 (step 1208).

In FIG. 11, acquisition module 710 (see also, FIG. 7) receives the response from account charging server 552 through interface component 702 (step 1108) that includes the charging rules for the charging policy of UE 908. Acquisition module 710 may store the charging rules from the response in rules cache 707. Acquisition module 710 may also acquire network information, such as KPIs related to traffic, bandwidth, QoS, etc. Rules engine 712 may then process the charging rules to formulate the slice selection policy for UE 908 (step 1109). For instance, rules engine 712 may process operator-provisioned rules and the subscriber profile associated with UE 908 to modify the charging rules provided by account charging server 552 if needed. For example, rules engine 712 may add data to one or more parameters of the charging rules as needed. Rules engine 712 may also modify one or more parameters of the charging rules based on the operator-provisioned rules, the subscriber profile, etc. Rules engine 712 may add one or more charging rules for UE 908, or delete one or more of the charging rules provided by account charging server 552 based on the operator-provisioned rules, subscriber profile, etc. Priority module 714 may optionally prioritize the charging rules for UE 908 (step 1110) based on a policy or criteria. For example, the policy used by priority module 714 may consider TOD, DOW, peak/off-peak time, network conditions, etc. Priority module 714 may also insert an indication of the priority in a parameter of the charging rules. Rules engine 712 then formats a policy response that includes the slice selection policy for UE 908, where the slice selection policy indicates one or more of the charging rules for UE 908 that are mapped to a network slice (step 1112). Rules engine 712 then sends the policy response to slice selection server 502 through interface component 708 (step 1114).

In FIG. 10, interface component 602 (see also, FIG. 6) of slice selection server 502 receives the policy response from policy control server 550 (step 1010) that includes the charging rules (i.e., slice selection policy) for UE 908. SSF 610 then selects a network slice or NSI for UE 908 based on the charging rules (step 1012) and selection criteria. The network slice may be a core network part (e.g., NFs in the core network), or a core network part and a RAN part. SSF 610 may select the network slice or NSI for UE 908 based on other information provided by UE 908 or in the subscriber profile associated with UE 908. SSF 610 then sends an attach response to access network 104 that includes a network slice ID for the network slice selected for UE 908 (step 1014). The network slice ID may comprise a NeS-ID that indicates a CCNF ID or type of CCNF, and indicates one or more SCNFs or type of SCNFs. SSF 610 may also insert a charging rule ID in the attach response for the charging rule mapped to the network slice selected for UE 908. SSF 610 may insert the charging rule ID in the attach response separately from the network slice ID, or SSF 610 may embed the charging rule ID into the network slice ID. Access network 104 will then forward the attach response with the network slice ID to UE 908 so that UE 908 is aware of the network slice that was selected during the attach procedure.

UE 908 may process the charging rule ID and network slice ID. If UE 908 discovers the charging rule and/or rate do not meet its expectation (assuming the subscriber has multiple service plans with multiple charging rules), UE 908 can re-request a new network slice with the same usage and service type(s). To do so, UE 908 may send another attach request to access network 104 with the network slice ID and the charging rule ID previously selected by SSF 610. In response to the other attach request, SSF 610 may re-consult with policy control server 550 and account charging server 552, or may identify the charging rules for UE 908 that are stored locally in memory 606. SSF 610 selects an alternate network slice or NSI for UE 908 based on the charging rules (step 1012) and alternate selection criteria. SSF 610 then sends another attach response to access network 104 that includes a network slice ID for the alternate network slice selected for UE 908 (step 1014). SSF 610 may also insert a charging rule ID in the other attach response for the charging rule mapped to the alternate network slice selected for UE 908. SSF 610 provides a technical benefit in that it is able to select an appropriate network slice for UE 908 based on charging rules for UE 908. SSF 610 not only considers the slice-specific network functions that meets service needs of UE 908, but considers charging applicable to UE 908. For example, SSF 610 may select a network slice that has a low or no-charge tariff for UE 908 when the network functions of that network slice still meet the service needs of UE 908. Thus, UE 908 will be charged less for usage of that network slice as compared to other network slices, which will cause the subscriber to be more satisfied with his/her service.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the disclosure is not limited to those specific embodiments. The scope of the disclosure is defined by the following claims and any equivalents thereof.

1. A system comprising:
a slice selection server of a network that is partitioned into network slices, the slice selection server comprises:
a first interface component configured to receive an attach request initiated by User Equipment (UE) to attach to the network;
a second interface component configured to communicate with a policy control server; and
a first processor that implements a slice selection function, where in response to the attach request, the slice selection function is configured to send a first request to the policy control server through the second interface component to obtain a slice selection policy for the UE, and to receive a first response from the policy control server through the second interface component that includes the slice selection policy indicating a plurality of charging rules for the UE that are each mapped to a different one of the network slices;
the slice selection function is configured to select a network slice for the UE based on the charging rules, and to send an attach response to the UE through the first interface component that includes a network slice identifier (ID) for the network slice selected for the UE.

2. The system of claim 1 wherein:
the slice selection function is configured to insert a charging rule ID in the attach response for one of the charging rules that is mapped to the network slice selected for the UE.

3. The system of claim 2 wherein:
the slice selection function is configured to embed the charging rule ID in the network slice ID.

4. The system of claim 1 further comprising:
the policy control server that comprises:
a third interface component configured to receive the first request from the slice selection server;
a fourth interface component configured to communicate with an account charging server; and
a second processor that implements an acquisition module configured to send a second request to the account charging server through the fourth interface component to obtain a charging policy for the UE, and to receive a second response from the account charging server through the fourth interface component that includes the charging policy indicating the charging rules for the UE that are each mapped to a different one of the network slices;
the second processor implements a rules engine configured to process the charging rules in the second response from the account charging server to formulate the slice selection policy for the UE, and to send the first response to the slice selection server through the third interface component that includes the slice selection policy indicating the charging rules for the UE that are each mapped to a different one of the network slices.

5. The system of claim 4 wherein:
the second processor further implements a priority module configured to prioritize the charging rules for the UE, and to insert an indication of the priority in the charging rules.

6. The system of claim 1 further comprising:
the account charging server that comprises:
a fifth interface component configured to receive the second request from the policy control server; and
a third processor that implements a charging policy manager configured to determine the charging rules for the UE that are each mapped to a different one of the network slices, and to send the second response to the policy control server through the fifth interface component that includes the charging policy indicating the charging rules for the UE that are each mapped to a different one of the network slices.

7. The system of claim 6 wherein:
the charging policy manager is configured to assign a validity timer to each of the charging rules, and to populate a parameter of the charging rules with the validity timer.

8. The system of claim 6 wherein:
the third processor further implements an account balance manager that maintains an account associated with the UE; and
the charging policy manager is configured to populate a parameter of the charging rules with information regarding the account.

9. The system of claim 6 wherein:
the third processor further implements a rating engine that determines tariffs for the network slices that are mapped to the charging rules; and
the charging policy manager is configured to populate a parameter of a charging rule with a tariff for a network slice mapped to the charging rule.

10. A method operable in a network that is partitioned into network slices, the method comprising:
receiving, in a slice selection server, an attach request initiated by User Equipment (UE) to attach to the network;
sending, in response to the attach request, a first request from the slice selection server to a policy control server to obtain a slice selection policy for the UE;
receiving a first response in the slice selection server from the policy control server that includes the slice selection policy indicating a plurality of charging rules for the UE that are each mapped to a different one of the network slices;
selecting, at the slice selection server, a network slice for the UE based on the charging rules; and
sending an attach response from the slice selection server to the UE that includes a network slice identifier (ID) for the network slice selected for the UE.

11. The method of claim 10 further comprising:
inserting a charging rule ID in the attach response for one of the charging rules that is mapped to the network slice selected for the UE.

12. The method of claim 11 wherein inserting a charging rule ID in the attach response comprises:
embedding the charging rule ID in the network slice ID.

13. The method of claim 10 further comprising:
receiving the first request in the policy control server from the slice selection server;
sending a second request from the policy control server to an account charging server to obtain a charging policy for the UE;
receiving a second response in the policy control server from the account charging server that includes the charging policy indicating the charging rules for the UE that are each mapped to a different one of the network slices;
processing, at the policy control server, the charging rules in the second response from the account charging server to formulate the slice selection policy for the UE; and
sending the first response from the policy control server to the slice selection server that includes the slice selection policy indicating the charging rules for the UE that are each mapped to a different one of the network slices.

14. The method of claim 13 further comprising:
prioritizing the charging rules for the UE; and
inserting an indication of the priority in the charging rules.

15. The method of claim 10 further comprising:
receiving the second request in the account charging server from the policy control server;
determining, at the account charging server, the charging rules for the UE that are each mapped to a different one of the network slices; and
sending the second response from the account charging server to the policy control server that includes the charging policy indicating the charging rules for the UE that are each mapped to a different one of the network slices.

16. The method of claim 15 further comprising:
assigning a validity timer to each of the charging rules; and
populating a parameter of the charging rules with the validity timer.

17. The method of claim 15 further comprising:
maintaining an account associated with the UE; and
populating a parameter of the charging rules with information regarding the account.

18. The method of claim 15 further comprising:
determining tariffs for the network slices that are mapped to the charging rules; and
populating a parameter of a charging rule with a tariff for a network slice mapped to the charging rule.

19. A non-transitory computer readable medium embodying programmed instructions executed by one or more processors, wherein the instructions direct the processors to implement:
a slice selection server of a network that is partitioned into network slices;
the slice selection server receives an attach request initiated by User Equipment (UE) to attach to the network;
in response to the attach request, the slice selection server sends a request to a policy control server to obtain a slice selection policy for the UE, and receives a response from the policy control server that includes the slice selection policy indicating a plurality of charging rules for the UE that are each mapped to a different one of the network slices;
the slice selection server selects a network slice for the UE based on the charging rules, and sends an attach response to the UE that includes a network slice identifier (ID) for the network slice selected for the UE.

20. The computer readable medium of claim 19 wherein:
the slice selection server inserts a charging rule ID in the attach response for one of the charging rules that is mapped to the network slice selected for the UE.

21-22. (canceled)
